(19) United States
(12) Patent Application Publication
(10) Pub. No.: US 2017/0277765 A1
(43) Pub. Date: Sep. 28, 2017

(54) SHELL DATABASE ARCHITECTURE FOR INVENTORY MANAGEMENT

(71) Applicant: Halliburton Energy Services, Inc., Houston, TX (US)

(72) Inventors: Donald Anthony Belcher, Duncan, OK (US); Wesley John Warren, Marlow, OK (US); Bryan Chapman Lucas, Duncan, OK (US)

(21) Appl. No.: 15/504,844

(22) PCT Filed: Nov. 19, 2015
(86) PCT No.: PCT/US2015/061618

§ 371 Date: Feb. 17, 2017

(51) Int. Cl. G06F 17/30; G06Q 10/08; G06F 9/54

(52) U.S. Cl. CPC G06F 17/30575; G06F 17/30501; G06F 17/30194; G06F 9/545; G06Q 10/087

(57) ABSTRACT

In accordance with presently disclosed embodiments, an inventory management system and method are provided. The inventory management system and method utilize an inverted database architecture that stores all the individual information related to each inventory item with the item itself, rather than just an identification number. Successive local, regional, and enterprise databases may be constructed from the item level up. That way, each inventory item effectively becomes a database, storing all its own data, and the higher level databases may be updated to reflect the information from the lower level databases when communication is available. This inventory management system of nested databases may be of particular use in the management of bulk material (e.g., powder, granular, or liquid) inventory for remote supply, transportation, and use applications.

### TECHNICAL FIELD

The present disclosure relates generally to inventory management, and more particularly, to a shell database architecture for inventory management in remote supply, transportation, and use applications.

### BACKGROUND

In inventory management systems, a large enterprise or global database is often used to record information relating to individual items in an inventory. Such information can include, for example, a current location of the item, product type, size, weight, quantity, supplier, and various other details about the item. Each item is uniquely identified with an identification number or code, such as a serial number, part number, or package number. The identification number is generally the only item-specific information stored physically on the item. All other item information is accessed from the enterprise database.

This type of inventory management system has several limitations, especially when used to track inventory that is transported, stored, and/or used in remote locations where real-time access to the enterprise database is intermittent or non-existent. For example, if inventory is moved around, used, or removed from the remote site while communication with the enterprise database is down, it can be difficult to maintain accurate information regarding the location, weight, quantity, and other properties of the inventory. This can lead to monetary losses due to items or materials becoming lost or unaccounted for in the inventory management system.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a schematic diagram of an inventory management system utilizing a shell database architecture, in accordance with an embodiment of the present disclosure;

FIG. 2 is a schematic diagram of an information handling system for communicating inventory information between subsequent database levels, in accordance with an embodiment of the present disclosure; and

FIG. 3 is a schematic diagram of a well site where bulk material inventory is maintained via the inventory management system of FIG. 1, in accordance with an embodiment of the present disclosure.

### DETAILED DESCRIPTION

Illustrative embodiments of the present disclosure are described in detail herein. In the interest of clarity, not all features of an actual implementation are described in this specification. It will of course be appreciated that in the development of any such actual embodiment, numerous implementation specific decisions must be made to achieve developers' specific goals, such as compliance with system related and business related constraints, which will vary from one implementation to another. Moreover, it will be appreciated that such a development effort might be complex and time consuming, but would nevertheless be a routine undertaking for those of ordinary skill in the art having the benefit of the present disclosure. Furthermore, in no way should the following examples be read to limit, or define, the scope of the disclosure.

Certain embodiments according to the present disclosure may be directed to systems and methods for managing inventory for supply, transportation, and use at a remote location (e.g., with intermittent or limited communication to a global database). Typically, inventory management systems rely on large global/enterprise databases to contain up-to-date information on each item in the inventory (e.g., location, product type, weight, quantity, supplier, etc.). This information is usually recorded, tracked, and managed in one enterprise database, and sub databases are formed by filtering information from the enterprise database.

In order for these traditional inventory tracking methods to be successful, accurate real-time communication must be available at all times at the location where inventory is being tracked and used. For some remote operations, however, dependable communication is not the norm. This may be the case, for example, in oil field locations or in military field applications. Without accurate information from the enterprise database, items can arrive at a location without any identifiable information. In addition, items that are already on location could be used or removed from location without an accurate log, which can increase costs due to customers not being billed accurately for the inventory used on location.

The disclosed inventory management systems and methods are designed to address these shortcomings associated with existing inventory management systems. Specifically, the disclosed inventory management system includes an inverted database architecture that stores all the individual information related to each inventory item with the item itself, rather than just an identification number. In some embodiments, successive local, regional, and enterprise databases may then be constructed from the item level up. In other embodiments, the enterprise database may be constructed directly from information stored at the inventory items. That way, each inventory item effectively becomes a database, storing all its own data, and the higher level database(s) may be updated to reflect the information from the lower level databases when communication is available.

This inventory management system of nested databases may be of particular use in the management of bulk material (e.g., powder, granular, or liquid) inventory for remote supply, transportation, and use applications. In some embodiments, this bulk material may be transported about a work site in reusable containers. In such instances, both the container and the bulk material may be properly tracked and inventoried via the updated item level database.

In some embodiments, the item level database may include data relating to the inventory item, and the data may be stored in a radio frequency identification (RFID) tag, or any other rewritable transmitting media (e.g., smart cards, micro-controllers with near-field communication, etc.). Such electronic data storage devices may store information about both the container and the product being carried in the container, and the devices may be used to easily store and maintain this information physically with the inventory item (e.g., container). In addition, the electronic data storage devices may be rewritable, so that the inventory information stored thereon may be updated, e.g., as material is used from the container. This may enable the inventory management system to accurately account for the partial use of bulk material (or other product) from containers, so that the remaining contents of the container are known and made available for future use.

In this manner, the RFID tags (or other rewritable electronic data storage components) may become active elements of the inventory management system, rather than passive item identifiers. The item level databases stored thereon may therefore act as the building blocks of the higher level databases (e.g., local, regional, enterprise).

In some embodiments, the rewritable electronic data storage component associated with an inventory item may also be designed to actively transmit a signal for location identification. That way, the electronic data storage component may not only store item information (e.g., container and product information), but may also be used to identify a relative location of the item (e.g., container) using phased array identification or using a global positioning system (GPS).

Using a bottom up system implemented through rewritable electronic data storage components disposed on individual inventory items may significantly reduce unnecessary material losses at remote locations. The disclosed techniques can also be used to help identify exactly where such material losses are commonly occurring.

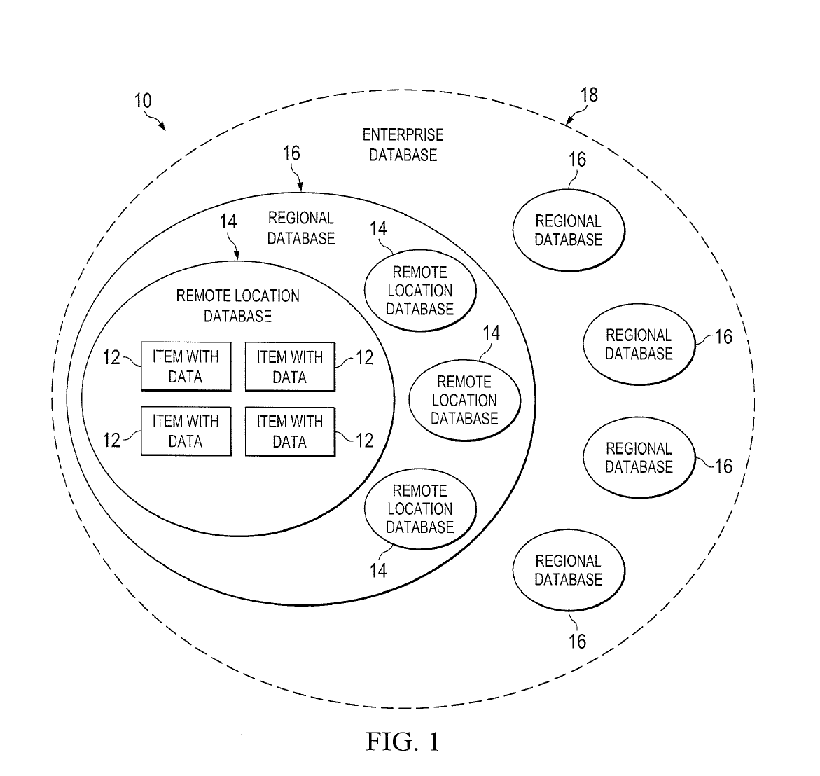

Turning now to the drawings, FIG. 1 is a schematic diagram illustrating an inventory management system 10 that utilizes a shell database architecture. The database architecture is organized by storing all individual information for each inventory item in a database on the item itself. That is, each item may include a unique item database 12, which maintains the information relating to the inventory item with the item.

When an item arrives at a remote location, the item information is read and stored on an intermediate database, such as a remote location database 14 (or local database). The local database 14 may be the next level up from the item database 12. In some embodiments, the local database 14 may correspond to a specific location or to a specific piece of equipment at a work site.

In the illustrated embodiment, the inventory management system 10 may also include one or more regional databases 16, which represent an additional intermediate database one level up from the local databases 14. The local databases 14 may communicate up to the corresponding regional database 16 when a connection is available between the local database 14 and the regional database 16. The regional databases 16 may then communicate inventory information up to an enterprise (or global) database 18 when a connection is available between the regional database 16 and the enterprise database 18.

Although three database levels (local 14, regional 16, and enterprise 18) are shown in FIG. 1, it should he noted that other embodiments of the inventory management system 10 may include as many, or as few, database levels as desired. For example, at one extreme, information from the item database 12 may be communicated directly to the upper level enterprise database 18. In other embodiments, the local databases 14 could be the only intermediate databases that communicate inventory information from the items directly to the enterprise database 18 (e.g., without a regional database). At the other extreme, multiple layers of intermediate databases (e.g., 2, 3, 4, 5, 6, or more) may be stacked between the local databases 14 and the enterprise database 18.

The bottom-to-top database architecture of FIG. 1 may reduce data loss in the inventory management system 10 due to connection issues that may frequently occur at a remote location. All inventory information relating to an item may be stored in the item database 12 using a rewritable data storage component disposed physically with the corresponding item. Thus, the inventory management system 10 eliminates the need for a consistent connection to the enterprise database 18 in order to retrieve inventory information.

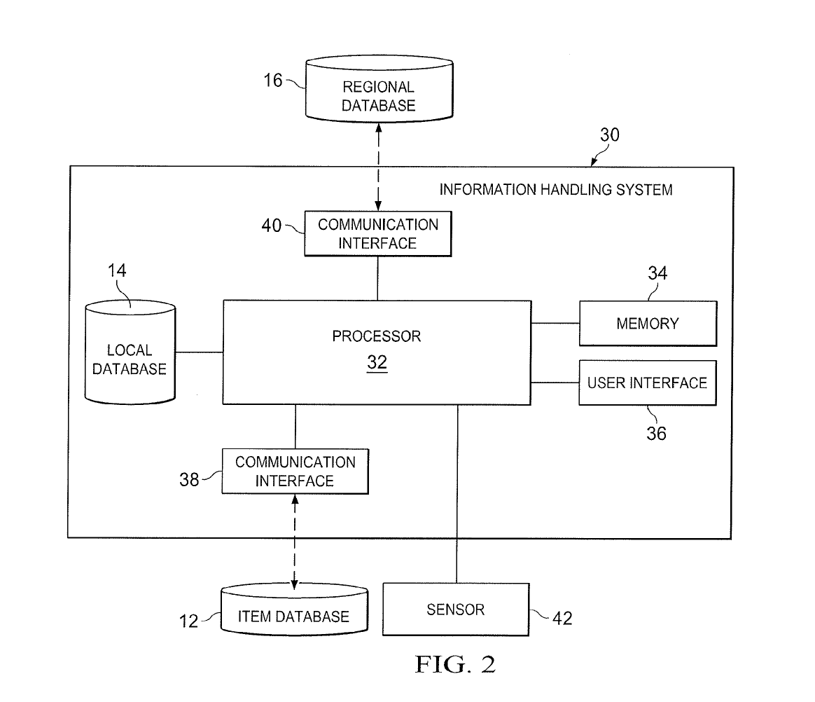

Inventory information may be communicated between subsequent levels of databases using one or more information handling systems. FIG. 2 illustrates one such information handling system 30 that may be used to access inventory data from a lower level database (e.g., item database 12) into an intermediate level database (e.g., local database 14) and transmit the inventory data from the intermediate level database to a higher level database (e.g., regional database 16). The information handling system 30 may include at least a processing component 32, a memory component 34, a user interface 36, and two communication interfaces 38 and 40. As shown, the processing component 32 may be communicatively coupled to the local database 14. In some embodiments, the processing component 32 may also be communicatively coupled to one or more sensors 42.

The processing component 32 may be operably coupled to the memory component 34 to execute instructions for carrying out the presently disclosed techniques. These instructions may be encoded in programs that may be executed by the processing component 32 to access, store, and transmit inventory information between various database levels. The codes may be stored in any suitable article of manufacture (such as the memory component 34) that includes at least one tangible non-transitory, computer-readable medium that at least collectively stores these instructions or routines. In this manner, the memory component 34 may contain a set of instructions that, when executed by the processing component 32, perform the disclosed inventory tracking methods.

The user interface 36 may include a display, speaker, or other output mechanism for providing inventory information to an operator as desired. In some embodiments, the user interface 36 may automatically output alerts to an operator, such as to notify the operator that an inventory tracking error has occurred and should be reconciled. The user interface 36 may also include an input device for manually entering information into the local level database 14 as needed.

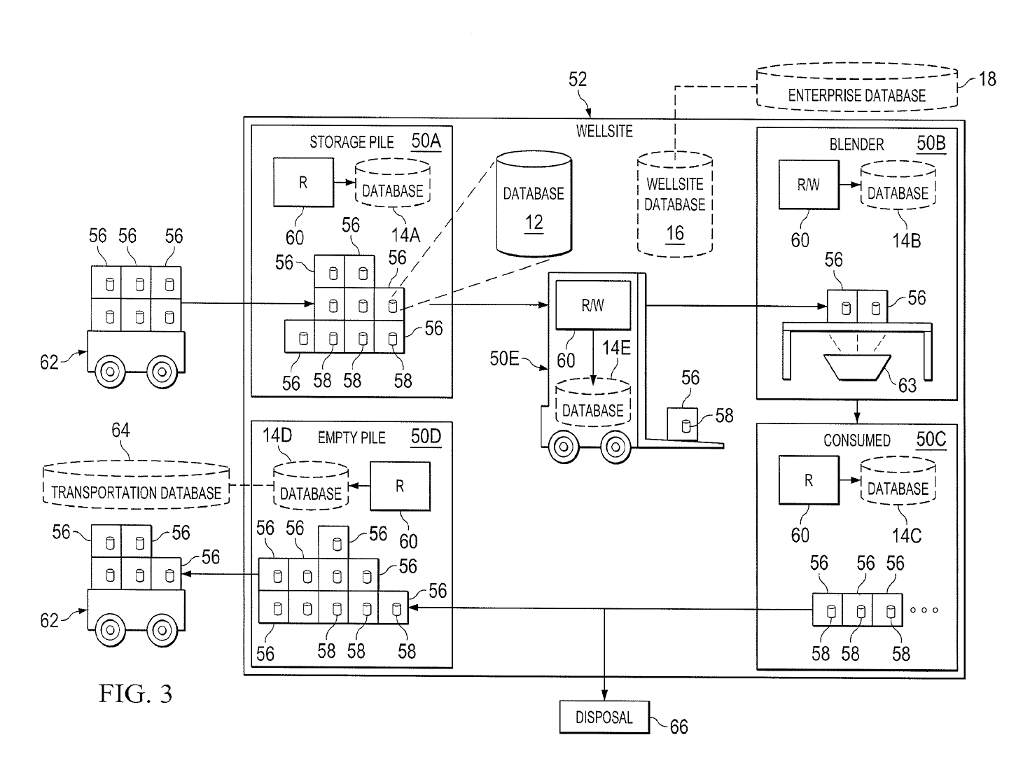

The communication interface 38 may facilitate communication between the item database 12 and the local database 14. In some embodiments, the communication interface 38 may include a reader/writer hardware component (e.g., 60 of FIG. 3) designed to retrieve information from the item database 12 and/or rewrite the information in the database 12 based on, for example, feedback received from the sensor 42.

The communication interface 40 may facilitate communication between the local database 14 and the regional database 16. The communication interface 40 may allow the regional level database 16 to access inventory information from the local database 14. The communication interface 40 may also enable the information handling system 30 to receive signals to update the local database 14 based on information received at the regional database 16.

One particular extension of the bottom-to-top shell database architecture described above may be utilized in remote oilfield applications. FIG. 3 illustrates one such example of an oilfield application, in which various pieces of equipment and/or locations 50 at a well site 52 correspond to the first level databases (e.g. local databases 14) and the well site 52 corresponds to a second level database (e.g., regional database 16). The shell database architecture of FIG. 1 may be implemented to accurately track inventory of bulk material being transported about the well site 52 in portable containers 56. As shown, an item database 12 may be stored with each portable container 56 that is manipulated about the well site 52. The item database 12 may include information specific to the container 56 itself and information specific to the bulk material contents of the container 56. The portable containers 56 may be manipulated relative to (or stored at) the different equipment/locations 50 about the well site 52. The enterprise database 18 may receive information from the regional database 16 corresponding to the well site 52. The enterprise database 18 may also receive information from other regional databases 16 corresponding to additional well sites 52 that are not shown.

The well site (regional) database 16 may include data received from several equipment (local) databases 14 such as, for example, a storage pile database 14A, a blender database 14B, a consumed database 14C, and an empty pile database 14D. These databases 14 may be associated with certain equipment 50 (or locations) at the well site 52. These equipment/locations 50 may include, for example, a storage pile 50A, a blender unit 50B, a consumed location 50C, and an empty pile 50D. The portable containers 56 may be stored in the storage pile 50A when brought to the well site 52, then moved to and emptied at the blender 50B. The portable containers 56 may then be transported to the consumed location 50C after being partially or fully emptied, and the empty containers 56 may be moved to the empty pile 50D to be transferred from the well site 52 and/or refilled. As shown, local databases 14E may also be included on and associated with one or more hoisting mechanisms 50E (e.g., forklifts, cranes, etc.) used to transport the portable containers 56 about the well site 52. In other embodiments, different combinations of equipment and/or locations 50 with associated databases 14 may be located throughout the well site 52.

The various local databases 14 may be used to track inventory of the bulk material being moved about the well site 52 in the portable containers 56. For example, when a portable container 56 is brought into proximity with a piece of equipment 50 (or location), the data from the item database 12 on the portable container 56 may be populated into the local database 14 associated with the piece of equipment 50 (or location). As described above, the data from the local databases 14 may be populated into the corresponding regional database 16 (e.g., associated with the well site 52) when communication is available. The data from one or more regional databases 16 (e.g., associated with different well sites 52) may be populated into the enterprise database 18 when communication is available.

As mentioned above, the portable containers 56 of bulk material being used throughout the well site 52 correspond to the inventory items being tracked by the database system, each inventory item having an item database 12. The individual information for each item (i.e., portable container 56) will be stored on the item itself. The information associated with a given portable container 56 may include all inventory information related to the contents of the container (e.g., weight, volume, product type, and material supplier). The information associated with the portable container 56 may also include information related to the container (e.g., type, size, location, etc.) being used to hold the bulk material.

In some embodiments, the information associated with a given portable container 56 may be stored on labels or a data sheet attached to the container 56. In such instances, the information may be manually entered into the local level databases 14 of the equipment 50 encountered by the container 56 on its journey about the well site 52. However, such manual entry of the information may be labor intensive and impractical.

For improved efficiency, data storage components 58 may be used to maintain the information associated with the inventory items (containers 56) physically with the items. In some embodiments, each bulk material container 56 may be labeled with a data storage component 58 (having the item database 12) that is rewritable and able to transmit data. The data storage component 58 may be an electronic data storage component. The electronic data storage components 58 may include any rewritable transmitting media such as, for example, RFID tags, smart cards, micro-controllers with near-field communication, or others. The amount of data needed for each portable container 56 may be easily stored on a QR code (2D bar code), near-field communication tag, RFID tag, or micro-controller. The information stored in the local database 12 via the data storage component 58 may then be read with a scanner appropriate for retrieving information from the associated technology (bar code, RFID, N-F communication, etc.). Regardless of the component used for physically storing the data of the item database 12 with the item (i.e., portable container 56), the data is able to be transported with the item and is available to be read into the subsequent upper level databases (e.g., 14, 16, and/or 18).

The electronic data storage component 58 may maintain the item database 12 to track the journey of the inventory item (e.g., portable container 56) throughout its life. The inventory information stored in the database 12 may be dynamically updated (rewritten) at different times as the container 56 is moved about the well site 52. For example, as the material stored in the container 56 is used at the blender 50B (or some other equipment at the well site 52), the data in the electronic data storage component may be updated to reflect the new amount of material in the container 56.

The various equipment and locations 50 about the well site 52 may be equipped with reader and/or writer hardware 60, as shown in FIG. 3. The reader hardware may scan the electronic data storage component 58 of a container 56 to read inventory information from the item database 12 into a corresponding local database 14. The writer hardware may rewrite at least a portion of the data stored in the item database 12 in response to signals from sensors (e.g., 42 of FIG. 2) such as load cells measuring the weight and/or presence of the container 56. The information may be rewritten to reflect, for example, the current weight or amount of material in the container 56, as well as the current location of the container 56 at the well site 52.

In some embodiments, the hardware 60 on some pieces of equipment 50 may include both a reader and writer, while the hardware 60 on other pieces of equipment 50 or locations may include just a reader. For example, the blender 50B may include both reader and writer hardware 60, enabling the electronic data storage component 58 to be rewritten periodically as the contents of the container 56 are output to the blender 50B. In addition, the hoisting mechanisms 50E and/or other equipment (e.g., depot station where the containers are filled) may feature reader and writer hardware 60. As shown, the storage pile 50A, consumed location 50C, and empty pile 50D may utilize just reader hardware 60 to read information into their corresponding databases 14A, 14C, and 14D.

It should be noted that other combinations of the equipment/locations 50 at the well site 52 may be equipped with readers and/or writers based on the inventory tracking needs at the well site 52. For example, in some embodiments, all of the available equipment/locations 50 in the well site 52 may be equipped with reader and writer hardware 60. In other embodiments, only the blender 50B may include writer hardware for updating the item database along with the reader hardware, while the other equipment 50 may just include reader hardware.

In some embodiments, the electronic data storage devices 58 may operate passively. That is, the electronic data storage devices 58 (e.g., RFID tags) may only be read or updated when in relatively close proximity to an appropriate reader/writer hardware component 60, since communication is initiated via the hardware 60. In other embodiments, it may be desirable to utilize active electronic data storage devices 58 (e.g., active RFID tags) for storing data associated with a particular inventory item. Each active device 58 may be designed to broadcast its own signal, such that the device 58 can be read from a greater distance than would be possible using passive electronic data storage devices 58.

In addition, such active electronic data storage devices 58 may enable the physical location of the device 58 (and container 56) to be identified in its relation to an array of sensors/readers 60 and other active devices 58 in the vicinity of the well site 52. Through phased array positioning/identification techniques, these active devices 58 may allow the inventory management system to track the devices 58 in space. Thus, the active devices 58 used to store the container information may also provide real-time locational information for each container 56 at the well site 52. This location information could be used to periodically check the inventory information for each container 56 at the well site 52.

Having now described a general layout of the database system at a remote well site 52, an example journey of a container 56 moving through the well site 52 will be provided. First, one or more containers 56 of bulk material may arrive at the remote well site 52. The containers may be delivered via a truck or any other desirable transportation system 62. As the transportation system 62 with the containers 56 passes an automatic scanning point (e.g., reader/scanner 60 at the storage pile 50A), the complete container inventory information may be read from the container database 12 into the storage pile database 14A on location. The “complete container inventory” may refer to all information regarding both the container 56 and the material contents of the container 56. The storage pile database 14A may communicate the inventory information of the container 56 to the well site database 16 when communication is available between the two.

A hoisting mechanism 50E may pick up the container 56 from the storage pile 50A to move it to another position at the well site 52. At this time, the hoisting mechanism 50E may read the inventory information from the container database 12 into the hoisting mechanism database 14E. The information read from the container database 12 may be used to confirm to the hoisting mechanism operator that the container 56 being lifted holds a desired type of bulk material. In some embodiments, the information read from the container database 12 may be used to determine instructions for where to transport the container 56. For example, if the information indicates that the container 56 is full of material, the hoisting mechanism 50E may move the container to the blender 50B. If the information indicates that the container 56 is empty, the hoisting mechanism 50E may instead move the container to the empty pile 50D.

If the container 56 is holding bulk material, the hoisting mechanism 50E may deliver the container to the respective equipment that will use the bulk material (e.g., blender, ADP™ Advanced Dry Polymer blender, sand handling equipment, fluids management trailer, etc.). In the illustrated embodiment, the blender 50B is the piece of equipment that will use the bulk material from the container 56. The reader hardware 60 on the blender 50B receiving the bulk material may scan the container 56 to read the container inventory information into the associated blender database 14B. This blender database 14B may communicate the inventory information to the well site database 16 when communication is available between the two. Based on the received information, the well site database 16 may identify which container 56 had been moved from the storage pile 50A to the blender 50B and update the storage pile database 14A accordingly.

The container 56 may be opened to release bulk material into an inlet (e.g., hopper 63) of the blender 509. The blender database 14B may verify that the correct material is being delivered to the blender 50B from the container 56, as well as monitor the rate and total amount of material used, based on signals from load cells or other sensors (e.g., 42 of FIG. 2) used at the blender 50B.

When the container 56 is disconnected from the blender 50B (or other equipment), and at given time intervals throughout the job, the electronic data storage component 58 may be updated to reflect the new bulk material quantity in the container 56. That is, the information stored in the container database 12 may be rewritten by the writer hardware 60 on the blender 50B to reflect the new quantity. Used inventory information (relating to the material that has been consumed at the blender) may also be recorded at the container and/or blender databases (12, 14B) to provide an accurate log for billing customers. Regularly updating the information on the electronic data storage component 58 may limit the amount of data lost in the event of an improper equipment shutdown, power failure, or other unintended event.

Once all (or a portion) of the bulk material is emptied from the container 56 into the blender 50B, the container 56 may be transported away from the blender 50B to the consumed location 50C and automatically scanned, such that the updated “used inventory” information from the container database 12 is populated into the consumed database 14C. The consumed database 14C may then communicate with the well site database 16 to track the inventory for correct billing to the customer.

If a disposable container 56 is being used (e.g., Super Sacks®), the physical transfer of the emptied container 56 to the consumed location 50C may involve the disposal (66) of the container 56. If a refillable/reusable container 56 is being used, the container 56 may be moved to the empty pile 50D to await transportation away from the well site 52. During this time, the information pertaining to the container 56 itself may be read from the container database 12 into the empty pile database 14D, while the information regarding the bulk material that was originally in the container 56 remains stored in the consumed database 14C. When the container 56 is removed from the well site 52 (e.g., via a transportation system 62), the container information may be removed or aged out of the empty pile database 14D and transferred to a transportation database 64 that is outside of the well site databases 16.

In some embodiments, the database management system may include additional logic to perform error tracking at various stages throughout the use of the container 56 of bulk material at the well site 52. This may involve sending an error message to an operator (via user interface 36 of FIG. 2) when the container 56 skips one or more steps in the process of moving through the well site 52. For example, if information from the container database 12 appears in the empty pile database 14D (or transportation database 64) without first passing through the blender and consumed databases 14B/14C, the system may output an error message to inspect the container 56. If the container 56 is full, it may be returned to the storage pile 50A. If the bulk material has been used, the corresponding databases (i.e., blender and consumed databases 14B/14C) may be manually corrected. This error checking may help to minimize incorrect billing of customers, or lost product being removed from the well site 52.

The database management system and method described above may improve inventory management in remote locations in a number of ways. The database structure may be used to maintain a highly accurate log of the location and amount of material being used throughout a job site, even when communication is not available to the enterprise database 18. Inventory information may be stored with time stamps in the well site database 16, and this information may be utilized to make decisions regarding ordering or requesting additional items (e.g., containers 56 of material) as needed at a job site (e.g., well site 52).

Since the databases are updated from the bottom up, a loss of communication with the enterprise database 18 cannot lead to a loss of information regarding the current location/amount of material in the individual containers 56 being moved about the job site 52. Thus, the system is able to more accurately determine what to bill customers, regardless of any other (less accurate) measurements that are taken at the job site 52. As noted above, the system allows for error checking, which can be used to identify persistent errors in sensor measurements or from a particular supplier, so that the errors can be fixed.

As described above, the system may use electronic data storage components 58 that can be automatically scanned by reader hardware as the item (e.g., container 56) is moved to a new location, instead of relying on personnel to manually scan each item. The data storage components 58 on the individual items may be rewritten or updated periodically to account for partially used containers 56 of material, for example. In addition, the data storage components 58 may be read as the items leave a location, to enable removal of item information from the higher level location database 14, to track material left in the containers 56, and to provide error checking for what material has been used during a job and billed to the customer.

Although the present disclosure and its advantages have been described in detail, it should be understood that various changes, substitutions and alterations can be made herein without departing from the spirit and scope of the disclosure as defined by the following claims.

What is claimed is:

1. A system, comprising:
an inventory item;
a data storage component disposed on the inventory item, wherein the data storage component comprises an item database for storing information about the inventory item;
at least one intermediate database for accessing the information about the inventory item from the item database when communication is available between the at least one intermediate database and the item database; and
an enterprise database, wherein the information about the inventory item is accessible by the enterprise database when communication is available between the at least one intermediate database and the enterprise database.

2. The system of claim 1, wherein the data storage component is rewritable to update the information about the inventory item stored in the item database.

3. The system of claim 2, further comprising an electronic writer component for rewriting the information about the inventory item stored in the item database.

4. The system of claim 1, further comprising an electronic reader component for reading the information about the inventory item from the data storage component to populate the at least one intermediate database.

5. The system of claim 1, wherein the at least one intermediate database comprises a local database for managing inventory specific to a location, and wherein the information about the inventory item is accessible by the enterprise database when communication is available between the local database and the enterprise database.

6. The system of claim 1, wherein the at least one intermediate database comprises:
a local database for managing inventory specific to a location; and
a regional database for managing inventory from multiple local databases;
wherein the information about the inventory item is accessible by the regional database when communication is available between the local and regional databases; and
wherein the information about the inventory item is accessible by the enterprise database when communication is available between the regional and enterprise databases.

7. The system of claim 6, wherein the inventory item comprises a container of material that is transportable about a well site, wherein the local database is associated with equipment or a location at the well site, and wherein the regional database is associated with the well site.

8. The system of claim 1, wherein the enterprise database contains only information about the inventory item that is accessed from the at least one intermediate database.

9. The system of claim 1, wherein the inventory item comprises a container of material for use in a remote location.

10. The system of claim 9, wherein the information about the inventory item stored in the item database is rewritable in response to changes in an amount of material in the container.

11. The system of claim 9, wherein the information about the inventory item comprises a weight of material, a type of material, a material supplier, a volume of the container, a location of the container, an operational status of the container, or a combination thereof.

12. The system of claim 1, wherein the data storage component comprises a radio frequency identification (RFID) tag, a smart card, a micro-controller, a near field communication component, or a combination thereof.

13. A method, comprising:
storing information about an inventory item in an item database via a data storage component disposed on the inventory item;
accessing the information about the inventory item by at least one intermediate database when communication is available between the at least one intermediate database and the item database; and
accessing the information about the inventory item by an enterprise database when communication is available between the enterprise database and the at least one intermediate database.

14. The method of claim 13, further comprising rewriting the information about the inventory item in response to changes to the inventory item.

15. The method of claim 13, further comprising automatically scanning the data storage component to read the information about the inventory item into an intermediate database when the inventory item is moved into a new location.

16. The method of claim 13, further comprising automatically scanning the data storage component and removing the inventory item from an intermediate database when the inventory item is removed from a location.

17. The method of claim 13, further comprising reading the information about the inventory item into an intermediate database associated with a piece of equipment, and handling the inventory item via the piece of equipment based on the information about the inventory item.

18. The method of claim 13, further comprising actively transmitting a signal from the data storage component for location identification.

19. The method of claim 13, further comprising:
accessing the information about the inventory item by a first intermediate database comprising a local database when communication is available between the local database and the item database;
accessing the information about the inventory item by a second intermediate database comprising a regional database when communication is available between the regional database and the local database; and
accessing the information about the inventory item by the enterprise database when communication is available between the enterprise database and the regional database.

20. The method of claim 19, further comprising:
updating the regional database based on the information about the inventory item received from a first local database; and
updating a second local database based on the information about the inventory item received from the regional database.
